(19) United States
(12) Patent Application Publication
(10) Pub. No.: US 2011/0063086 A1
(43) Pub. Date: Mar. 17, 2011

(54) RF TAG READER AND WRITER

(75) Inventor: Sadatoshi Oishi, Shizuoka-ken (JP)

(73) Assignee: TOSHIBA TEC KABUSHIKI KAISHA, Tokyo (JP)

(21) Appl. No.: 12/874,485

(22) Filed: Sep. 2, 2010

(30) Foreign Application Priority Data
Sep. 11, 2009 (JP) 2009-210895

(51) Int. Cl. G06K 7/01

(52) U.S. Cl. 340/10.2

(57) ABSTRACT

There is provided an RF tag reader and writer including: a transmission antenna configured to transmit a desired signal; a receiving antenna configured to receive radio waves transmitted from an RF tag which is a communication target; a return-loss determination unit configured to determine the receiving intensity of the receiving antenna with respect to reflected waves of radio waves radiated from the transmission antenna; and a reading control unit configured to start a reading operation of the RF tag by being triggered by a return loss value determined by the return-loss determination unit.

### CROSS-REFERENCE TO RELATED APPLICATION(S)

This application is based upon and claims the benefit of priority from Japanese Patent Application No. 2009-210895, filed on Sep. 11, 2009; the entire contents of which are incorporated herein by reference.

### FIELD

The embodiments in this specification relate to a technique for controlling reading timing of RF tags by an RF tag reader and writer.

### BACKGROUND

In the related art, a configuration using an RF tag reader and writer and an antenna gate provided at the entrance between a backroom storage and a sales floor is known as a technique for managing comings and outgoings of commercial products between the backroom storage side and the sales floor (store space) side in a supermarket, or the like (see Patent Document 1, for example).

When a commercial product to which an RF tag and a bar-code label are attached passes through the antenna gate, the RF tag reader and writer reads the commercial product information written in the RF tag. The information read in such a manner is transmitted to a store server and used for the stock management in the store.

In addition, an antenna is used for both transmitting and receiving information by a circulator or the like in a general RF tag reader and writer, and a technique is known in which a receiving circuit is protected from excessive input due to a malfunction of the antenna with such a configuration (see Patent Document 2, for example).

According to the technique in the related art as described above, it is required to detect comings and outgoings of commercial products with an optical sensor or the like and control the signal transmission from the RF tag reader and writer, in order to manage incoming and outgoing of the commercial products between the sales floor and the backroom storage. Of course, a configuration can also be considered in which the RF tag reader and writer always executes a reading operation of RF tags without using an optical sensor or the like. However, such a configuration may result in a decrease in the utilization efficiency of a frequency, and may cause adverse effects such as interference with another RF tag reader and writer.

### BRIEF DESCRIPTION OF THE DRAWINGS

FIG. 1 is a diagram schematically illustrating a product management system using an RF tag reader and writer according to a first embodiment.

FIG. 2 is a diagram illustrating a schematic configuration of a circuit in the RF tag reader and writer according to the first embodiment.

FIG. 3 is a graph for illustrating operations of the RF tag reader and writer according to the first embodiment.

FIG. 4 is a flow chart for illustrating operations of the RF tag reader and writer according to the first embodiment.

FIG. 5 is a diagram illustrating a schematic configuration of a circuit in an RF tag reader and writer according to a second embodiment.

### DETAILED DESCRIPTION

According to embodiments, an RF tag reader and writer generally includes a transmission antenna, a receiving antenna, a return-loss determination unit, and a reading control unit. The transmission antenna transmits a desired signal. The receiving antenna receives radio waves transmitted from an RF tag which is a communication target. The return-loss determination unit determines a receiving intensity in the receiving antenna with respect to reflected waves radiated from the transmission antenna. The reading control unit starts the reading operation for the RF tag, using the value of return loss determined by the return-loss determination unit as a trigger.

Hereinafter, the embodiments will be described with reference to accompanying drawings.

### First Embodiment

First, a first embodiment will be described.

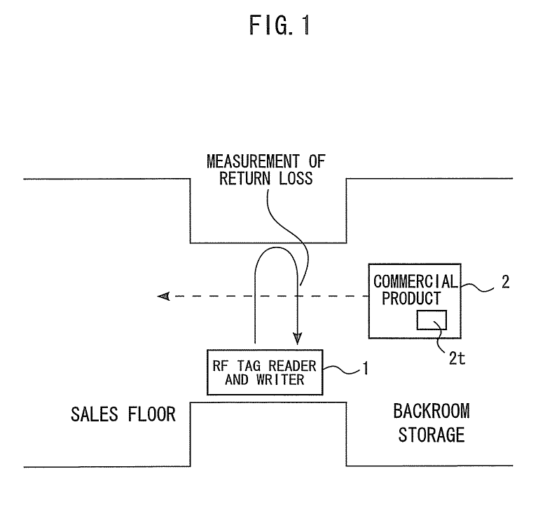

FIG. 1 is a diagram schematically illustrating a product management system using an RF tag reader and writer according to the first embodiment.

As shown in FIG. 1, the RF tag reader and writer 1 according to this embodiment is disposed, for example, at a gate between a backroom storage where commercial products 2, to each of which an RF tag is attached, are stored and a sales floor where the commercial products 2 stored in the backroom storage are to be displayed.

The RF tag reader and writer 1 disposed at such a position can read RF tags 2t attached to the commercial products 2 passing through the gate, and comprehend that the commercial products were moved from the backroom storage side to the sales floor side.

Hereinafter, a detailed description will be made of the RF tag reader and writer 1 according to this embodiment.

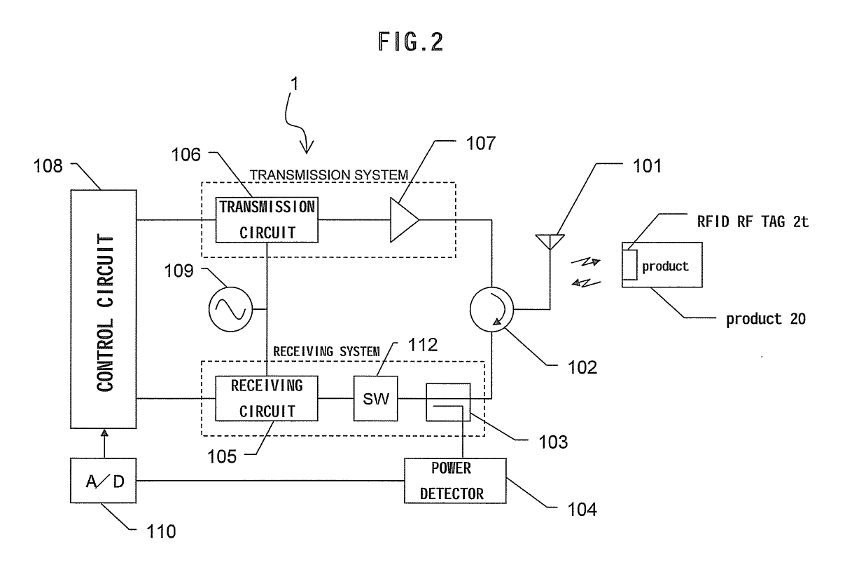

FIG. 2 is a diagram illustrating a schematic configuration of a circuit in the RF tag reader and writer according to the first embodiment.

As shown in the same drawing, the RF tag reader and writer 1 of the first embodiment includes an antenna 101 (corresponding to the transmission antenna and the receiving antenna), a circulator 102, a coupler 103, a power detector 104, a receiving circuit 105, a transmission circuit 106, a power amplifier 107, a control circuit 108, an oscillator 109, an A/D converter 110, and an RF switch 112.

According to the RF tag reader and writer 1 of this embodiment, a single antenna 101 can be caused to function both as a transmission antenna for transmitting signals to the RF tags 2t and as a receiving antenna for receiving signals returning from the RF tags 2t, with a use of the circulator 102.

The transmission circuit 106 and the power amplifier 107 constitute a transmission system in the RF tag reader and writer 1 of this embodiment. In addition, the coupler 103, the power detector 104, and the receiving circuit 105 constitute a receiving system thereof. The oscillator 109 is supplied for both the transmission circuit 106 and the receiving circuit 105, and the control circuit 108 controls the transmission circuit 106 and the receiving circuit 105. In addition, the control circuit 108 can control the gain of the power amplifier 7 and arbitrarily set the transmission power of the RF tag reader and writer 1.

The power amplifier 107 amplifies a signal output from the transmission circuit 106 to about 31 dBm, and the antenna 101 transmits the signal via the circulator 102. Although an LPF (Low Pass Filter) is normally inserted between the antenna 101 and the circulator 102 to suppress unnecessary higher harmonic waves, a description thereof will be omitted here.

The signal received by the antenna 101 and the reflected waves of the transmission signal due to mismatch or malfunction of the antenna 101 enter into the receiving circuit 105 via the circulator 102, the coupler 103, and the RF switch 112. The coupler 103 branches a part of the signal directing from the circulator 102 to the receiving circuit 105, and the branched signal is input to the power detector 104. The power detector 104 is constituted by, for example, a Schottky diode and outputs a voltage in accordance with the power of the input signal. The A/D converter 110 converts the output signal from the power detector 104 to a digital signal, and the digital signal is input to the control circuit 108.

The RF switch 112 is provided for protecting the receiving circuit 105, controlled by the control circuit 108, and is usually in an ON state. If the reflected waves of the transmission signal becomes larger due to mismatch or malfunction of the antenna 101, and the output signal from the power detector 104, which was converted to a digital signal by the A/D converter 110, exceeds a prescribed value, the control circuit 108 turns off the RF switch 112 and block the input line of the receiving circuit 105.

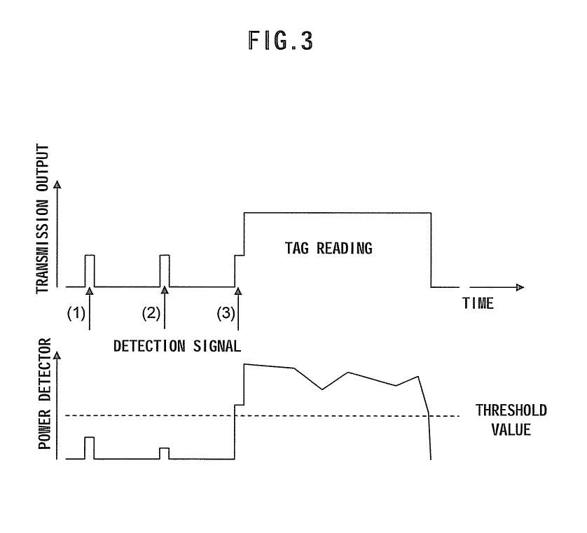

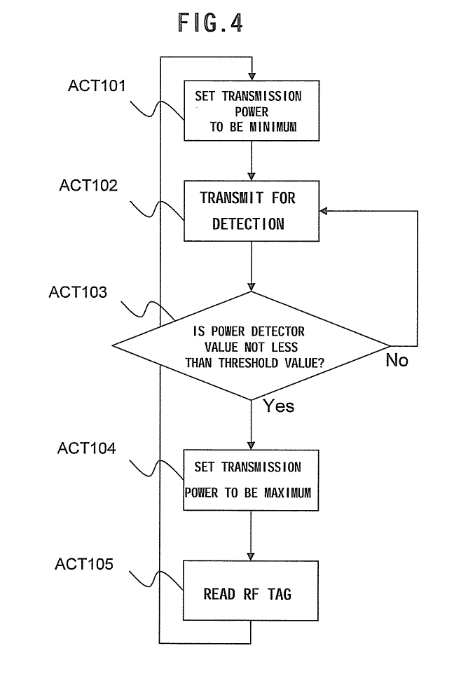

Next, a description will be made of the operations of the RF tag reader and writer 1 of this embodiment with reference to the graph shown in FIG. 3 and the flow chart shown in FIG. 4. The graph in the upper part of FIG. 3 shows a relationship between “the magnitude of the transmission output of the RF tag reader and writer” and “time”, and the graph in the lower part of FIG. 3 shows a relationship between “the signal intensity detected by the power detector” and “time”.

First, the control circuit 108 of the RF tag reader and writer 1 controls the gain of the power amplifier 7 and sets the transmission power to be 10 dBm, for example (Act 101).

Next, the transmission circuit 106 of the RF tag reader and writer 1 generates an unmodulated pulse of about 10 microseconds to 100 microseconds, for example, as a detection signal (1). The power amplifier 107 amplifies this detection signal (1), and the antenna 101 transmits the detection signal (1) via the circulator 102 (Act 102).

In addition, a carrier sense for monitoring the transmission of another network is performed before transmitting the detection signal in some cases depending on the standard of the operation region. However, since the carrier sense does not have a direct relationship with the configuration of the present invention, the flow chart in FIG. 4 does not show the carrier sense.

Here, if no commercial products or obstacles exist in the vicinity of the antenna 101, the intensity of the signal entering from the transmission unit to the receiving unit drops to the minimum intensity. Accordingly, the output of the power detector 104 reaches not more than a threshold value (No in Act 103), and the transmission circuit 106 transmits a detection signal (2) again after a predetermined time passes (Act 102).

If products 20 exist in the vicinity of the antenna 101 when a detection signal (3) is transmitted, the products 20 reflect the unmodulated pulse of the detection signal (3), and the output signal of the power detector 104 exceeds the threshold value (Act 103). As described above, the control circuit 108 and the power detector 104 function as the return-loss determination unit and determine the receiving intensity in the antenna 101 with respect to the reflected radio waves radiated from the antenna 101.

If the products 20 are located close to the antenna 101, the impedance of the antenna 101 greatly varies. Accordingly, reflection due to the mismatch of the antenna 101 becomes greater. In such a case, the output signal of the power detector 104 exceeds the threshold value (Yes in Act 103).

Subsequently, the control circuit 108 (corresponding to the reading control unit) sets the transmission power to be a maximum value of 30 dBm, for example, by being triggered by the determination that the output signal of the power detector 104 (return loss) exceeded the threshold value (Act 104) and starts the RF tag reading operation (Act 105). As described above, the intensity of the radio waves radiated from the antenna 101 for the determination of the return loss is set to be lower than that of the radio waves radiated when the RF tag reader and writer 1 reads the RF tags.

As described above, it is possible to control the start timing of the RF tag reading operation by the RF tag reader and writer 1 in accordance with the actual movement of the commercial products without providing a special sensor such as an optical sensor by using the power detector 104 for protecting the receiving system and the short unmodulated pulse as a detection signal.

In addition, the period of the radio wage radiated from the antenna 101 for the determination of the return loss is preferably determined based on the average speed at which the commercial products with the RF tags as reading targets attached thereto move between the backroom storage and the sales floor.

For example, it is preferable to transmit the radio waves for the return loss detection at a period of not more than 100 ms if a moving speed of a commercial product corresponds to a walking speed of a person who carries the commercial product (1 to 1.5 m/second), and a detectable range of the antenna is 20 cm. It is needless to say that the period, the duty ratio, and the like of the radio waves for the return loss detection can be appropriately set and changed in accordance with an actual use environment of the RF tag reader and writer.

### Second Embodiment

Next, a second embodiment will be described.

The second embodiment is a modified example of the first embodiment described above. Hereinafter, the same reference numerals will be given to parts having the same functions as those of parts which were already described in the first embodiment, and description thereof will be omitted.

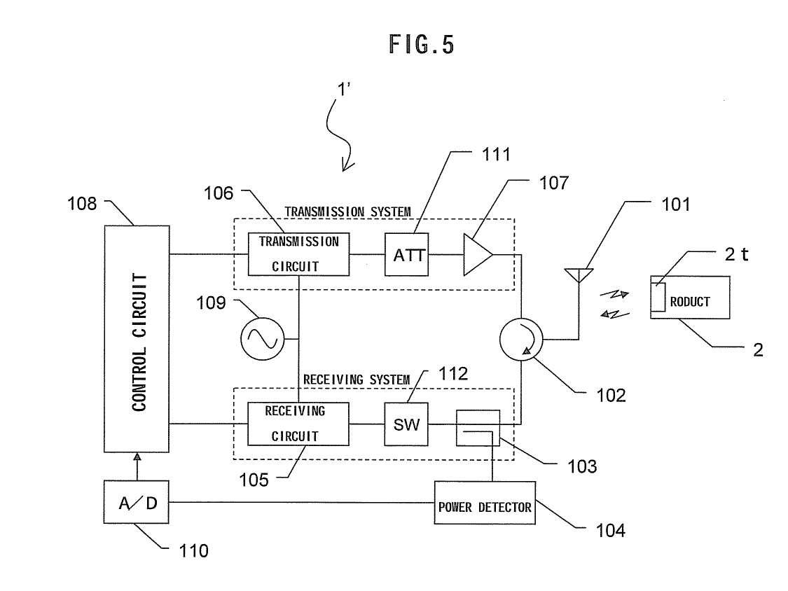

FIG. 5 is a diagram illustrating a schematic configuration of a circuit in an RF tag reader and writer 1′ according to the second embodiment.

The RF tag reader and writer 1′ of the second embodiment further includes a variable attenuator 111 between the transmission circuit 106 and the power amplifier 107. The control circuit 108 controls the attenuation of this variable attenuator 111, and the transmission power of the RF tag reader and writer 1′ can be arbitrarily set by allowing the power input to the power amplifier 107 to be variable. In the circuit configuration shown in FIG. 5, the gain of the power amplifier 107 is fixed.

### Third Embodiment

Next, a third embodiment will be described.

The third embodiment is a modified embodiment of the respective embodiments described above. Hereinafter, the same reference numerals will be given to parts having the same functions as those of parts which were already described in the first embodiment, and description thereof will be omitted.

In the respective embodiments described above, the RF tag reading operation is started if the determined return loss value exceeds the threshold value. However, the present invention is not limited thereto. In this embodiment, the control circuit 108 (corresponding to the reading control unit) sets the transmission power to be a maximum value of 30 dBm, for example, by being triggered by the determination that the output signal of the power detector 104 (return loss) dropped below the threshold value, and starts the RF tag reading operation.

If a package of a commercial product moving between the backroom storage and the sales floor or a package of the container or the like used for carrying the commercial product has a characteristic of absorbing radio waves, the radio wave reflection intensity detected at the time of passing through the gate between the backroom storage and the sales floor does not always increase, and may decrease in some cases. Accordingly, this embodiment provides an example of a configuration capable of handling the case in which the radio wave reflection intensity decreases when the commercial product passes through the gate in the above-described manner.

As described above, the RF tag reader and writer in which the transmission unit and the receiving unit use a single antenna is provided with a unit for measuring the reflected waves of the radio waves which is transmitted by the RF tag reader and writer itself, in order to protect the receiving system. Accordingly, the RF tag reader and writers of the above-described respective embodiments employ a configuration of intermittently transmitting an unmodulated pulse at a predetermined interval, measuring a magnitude of the reflected waves by the power detector, and thereby detecting the existence of the reading target. With such a configuration, it is possible to efficiently start the RF tag reading operation without using a special sensor such as an optical sensor for detecting the movement of the commercial products.

As described above in detail, according to the technique disclosed in this specification, it is possible to provide a technique for controlling the reading timing of the RF tags by the RF tag reader and writer without adding a special sensor such as an optical sensor and for suppressing a decrease in the utilization efficiency of the radio frequency.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An RF tag reader and writer comprising:
a transmission antenna configured to transmit a desired signal;
a receiving antenna configured to receive radio waves transmitted from an RF tag which is a communication target;
a return-loss determination unit configured to determine a receiving intensity of the receiving antenna with respect to reflected waves of radio waves radiated from the transmission antenna; and
a reading control unit configured to start a reading operation of the RF tag by being triggered by a return loss value determined by the return-loss determination unit.

2. The reader and writer according to claim 1,
wherein the transmission antenna and the receiving antenna are constituted by a single antenna.

3. The reader and writer according to claim 1,
wherein the reading control unit starts the reading operation of the RF tag when the return loss value determined by the return-loss determination unit exceeds a threshold value.

4. The reader and writer according to claim 1,
wherein the reading control unit starts the reading operation of the RF tag when the return loss value determined by the return-loss determination unit drops below a threshold value.

5. The reader and writer according to claim 1,
wherein the return-loss determination unit determines a receiving intensity of the receiving antenna with respect to reflected waves of unmodulated waves radiated from the transmission antenna.

6. The reader and writer according to claim 1,
wherein the intensity of the radio waves radiated from the transmission antenna for the return loss determination by the return-loss determination unit is lower than the intensity of the radio waves radiated when the RF tag reader and writer reads the RF tag.
